(19) United States
(12) Patent Application Publication
(10) Pub. No.: US 2005/0289359 A1
(43) Pub. Date: Dec. 29, 2005

(54) PREVENTING THE REMOVAL OF REMOVABLE DEVICES

(75) Inventors: Hidetoshi Mori, Kanagawa-ken (JP); Ken Sasaki, Kanagawa-ken (JP); Takashi Yomo, Kanagawa-ken (JP)

Correspondence Address: LENOVO (SINGAPORE) PTE. LTD., BUILDING 675, MAIL C-137, 4401 SILICON DRIVE, DURHAM, NC, 27709, US

(73) Assignee: LENOVO (SINGAPORE) PTE. LTD., SINGAPORE (SG)

(21) Appl. No.: 10/908,732

(22) Filed: May 24, 2005

(30) Foreign Application Priority Data
May 31, 2004 (JM) JP2004-161885

(51) Int. Cl. G06F 11/30; G06F 12/14; H04L 9/32

(52) U.S. Cl. 713/193

(57) ABSTRACT

A device registration part 52 registers the information regarding devices of theft prevention object in a DB 53 for devices of theft prevention object. A device event monitoring part 54 receives the notification of information regarding a removal request or a removal action for a device. A device detection part 55 acquires the detailed information regarding the device for which the removal request or the removal action is made. A device identification part 56 determines whether the device on which the detailed information is acquired is registered in the DB 53 for devices of theft prevention object. A password authentication part 57 requests password authentication, if the device is registered in the DB 53 for devices of theft prevention object. A warning control part 59 issues a warning in response to the password authentication part 57 not properly performing authentication.

### BACKGROUND of the INVENTION

The present invention relates to the operational control of a computer, and more particularly to a control for preventing the removal of a removable device connected to a computer.

There exist many personal computers (referred to below as a “PC”) which are placed in public spaces so that they can be used by many unspecified users. For example, PCs are placed for demonstration at PC shops, or also placed at schools, libraries, culture centers, hotel lobbies, Internet cafes, etc.

However, since many unspecified users are permitted to use such PCs placed at public spaces, they are subject to theft. Thus various measures are currently taken to prevent the theft of a PC, including fixing by a wire, such as Kensington lock.

Such measures, however, have no effect on an external keyboard or mouse, or a removable device which is connected to a Device Bay or a PCMCIA socket, etc.

Thus, this problem is conventionally addressed by requesting the input of a password, in response that a request is made to remove a device, or in response that an attempt is made to forcibly remove a device, and permitting the removal, if the password is properly authenticated (for example, refer to Patent Documents 1 and 2).

[Patent Document 1] Published Unexamined Patent Application No. 7-219666 (pp. 6 and 7, FIG. 6)

[Patent Document 2] Published Unexamined Patent Application No. 9-114546 (pp. 6 and 7, FIGS. 6 and 7)

### SUMMARY OF THE INVENTION

However, as with the related art approach of Patent Documents 1 and 2, when the input of a password is requested without exception independently of whether a device to be removed is originally attached to the PC, operability or ease of operation can be impaired. For example, even when the administrator of a shared PC attaches his own device to the shared PC to conduct a file copy operation, etc. and then attempts to remove the device, the input of a password can be requested. Thus, “Key lock free mode” may be set to avoid the password input request when a device is installed/removed for such legitimate reasons. It is very troublesome, however, to input a password to set “Key lock free mode” whenever performing an operation by use of one's own device.

Embodiments of the invention are disclosed which solve the above-mentioned technical problems, and it is a purpose of the invention to prevent a device requiring removal prevention from being removed without impairing the operability in removing a device not requiring removal prevention.

It is another purpose of the invention to prevent a device requiring removal prevention from being removed without impairing the operability in removing a device not requiring removal prevention even when the information for uniquely identifying the device such as the serial number cannot be acquired for the device.

According to the embodiments of the present invention, when a device registered in advance is removed, the validity of the action is verified. Specifically, a computer according the invention comprises a registration instructing part for instructing the registration of the first information regarding a removable device of removal prevention object; a database for storing the first information the registration of which is instructed by the registration instructing part; a determination part for determining whether or not the second information regarding the removable device for which a removal request or a removal action is made is stored in the database; and a verification part for verifying the validity of the removal request or the removal action, if the determination part determines that the second information is stored in the database. According to such a configuration, it becomes possible to issue a warning only when a device originally attached to a computer is removed. Consequently, the administrator of a computer can unrestrainedly use his own memory key, micro drive or the like, which is brought to the computer for file copy, etc.

The verification of the validity can be conducted, for example, by use of password authentication. In this case, the database stores a password set for each removable device of removal prevention object; the verification part verifies the validity of a removal request or a removal action according to the authentication which uses the password set for the removable device for which the removal request or the removal action is made.

A warning is issued against an invalid removal request or an invalid removal action, including cases such as forceful removal of a device without inputting a password. Specifically, the computer according to the invention comprises a warning part for issuing a warning when it is determined, based on the verification result given by the verification part, that the removal request or the removal action is invalid. In this case, the warning methods includes a flashy indication on a display screen, a maximum audio output from a loudspeaker attached to the system, and sending an alert message to the administrator in the case where the system is connected to a network.

In addition, it is also possible to lift the warning when the removed device is returned. In this case, according to the computer of the invention, the database stores the identification information for uniquely identifying a removable device as the information regarding the removable device of removal prevention object; the verification part verifies the validity of the removal action made for the removable device, if the identification information regarding the removable device is stored in the database; the warning part halts the warning if the identification information of the removable device for which the installing action is made is stored in the database. Alternatively, as the information regarding the removable device of removal prevention object, the database stores the information regarding the kind and connection destination of the removable device; the verification part verifies the validity of the removal action made for the removable device, if the information regarding the kind of the removable device and the information regarding the connection destination to which the removable device has been connected are stored in the database; the warning part halts the warning if the information regarding the kind of the removable device for which the installing action is made and the information regarding the connection destination to which the removal disk is connected are stored in the database.

It is understood that an input panel for inputting a password may be displayed on the screen even during the warning state, and the warning is lifted when the password is input.

The present invention can be perceived to be a method for preventing the removal of a removable device of removal prevention object by means of a computer. In this case, the method for preventing the removal of a removable device comprises: a step of registering, by means of the computer, the information regarding the removable device of removal prevention object in a predetermined database; and a step of issuing a warning when the information regarding the removed removable device is registered in the database.

The present invention can also be perceived to be a program for enabling a computer to implement predetermined functions. In this case, the program according to the invention enables the computer to implement; a function of registering the information regarding a removable device of removal prevention object in a predetermined database; a function of determining whether or not the information regarding the removed removable device is registered in the database; and a function of issuing a warning when it is determined that the information regarding the removed removable device is registered in the database.

According to the invention, it is possible to prevent a device requiring removal prevention from being removed without impairing the operability in removing a device not requiring removal prevention.

### BRIEF DESCRIPTION OF THE DRAWINGS

Some of the purposes of the invention having been stated, others will appear as the description proceeds, when taken in connection with the accompanying drawings, in which:

FIG. 1 is a diagram showing a hardware configuration of a computer system to which the invention is applied;

FIG. 2 is a block diagram showing a functional configuration of a computer system according to an embodiment of the invention;

FIG. 3 is a diagram showing exemplary storage contents of a theft prevention object device DB according to the embodiment;

FIG. 4 is a flowchart showing the operation of the computer system according to the embodiment;

FIG. 5 is a flowchart showing the operation of the computer system according to the embodiment;

FIG. 6 is a flowchart showing the operation of keeping the computer system at work as the premise of the embodiment; and

FIG. 7 is a flowchart showing the operation of keeping the computer system at work as the premise of the embodiment.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

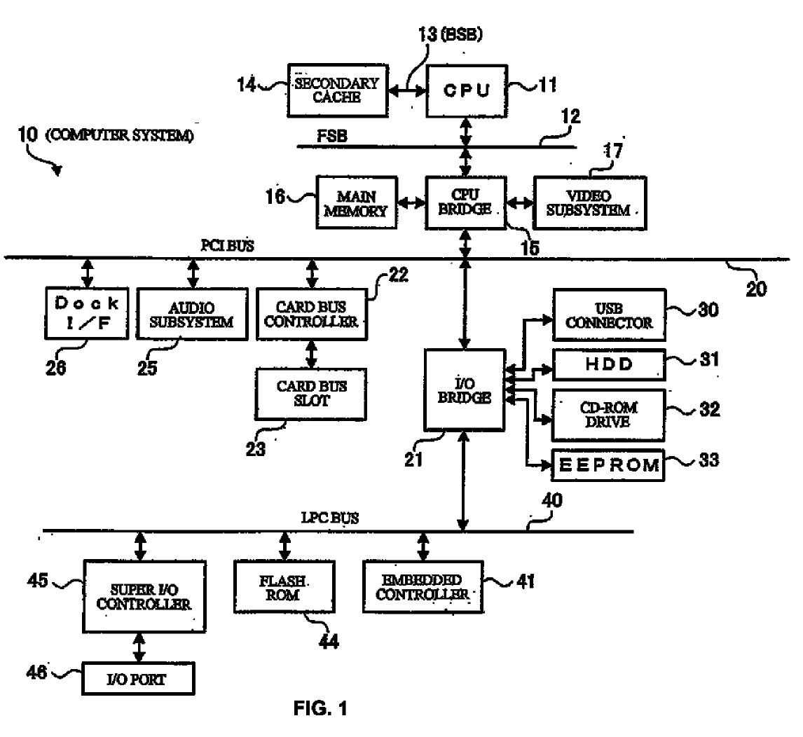

Referring now more particularly to the accompanying drawings, in which like numerals indicate like elements or steps throughout the several views, FIG. 1 is a diagram showing a hardware configuration of a computer system 10 according to the embodiment of the invention.

In the computer system 10 shown in FIG. 1, a CPU 11 executes various arithmetic operations by program control, thereby controlling the whole computer system 10. The CPU 11 and each component are interconnected to each other via three levels of buses: a FSB (Front Side Bus) 12 being a system bus, a PCI (Peripheral Component Interconnect) bus 20 being a bus for high-speed I/O devices and a LPC (Low Pin Count) bus 40 being a bus for low-speed I/O devices. The CPU 11 can achieve high-speed processing by storing program codes and data in cache memory. Recently, in addition to SRAM of about 128 Kbytes integrated as the primary cache into the CPU 11, the secondary cache 14 of about 512 Kbytes to 2 Mbytes is disposed via a BSB (Back Side Bus) 13 being a dedicated bus in order to compensate for the lack of memory capacity. It is also possible to avoid the use of a package with many terminals by omitting the BSB 13 and connecting the secondary cache 14 to the FSB 12, thereby reducing the cost.

The FSB 12 and PCI bus 20 are connected to each other via a CPU bridge (Host-PCI bridge) 15 referred to as a memory/PCI chip. The CPU bridge 15 includes a memory controller function of controlling an access operation to a main memory 16, a data buffer for adjusting the difference of data transfer rate between the FSB 12 and PCI bus 20, and the like. The main memory 16 is a writable memory used as an reading area into which the execution program of the CPU 11 is read, or as an operational area into which the processing data of the execution program is written. The main memory 16 is composed of plural of DRAM chips, for example. The execution program includes an OS, various drivers for operating the hardware of peripheral devices and application programs for executing particular tasks.

A video subsystem 17, which is a subsystem for implementing a function relevant to image display, includes a video controller. The video controller processes drawing commands from the CPU 11 to write the processed drawing information into a video memory and at the same time reads out the drawing information from the video memory to output it as drawing data to a monitor display such as a crystal liquid display (LCD).

The PCI bus 20 is a bus capable of performing a relatively high-speed data transfer. Connected to the PCI bus 20 are an I/O bridge 21 (also called Southbridge or I/O hub), a card bus controller 22, an audio subsystem 25, a docking station interface (Dock I/F) 26, etc.

The I/O bridge 21, which is a control circuit performing a bridge function between the PCI bus 20 and LPC bus 40, includes such functions as DMA control, programmable interrupt controller (PIC), programmable interval timer (PIT), IDE (Integrated Device Electronics) interface, USB (Universal Serial Bus), SMB (System Management Bus) interface. The I/O bridge 21 has built-in real-time clock (RTC).

The DMA controller function serves to execute data transfer between peripheral devices (FDD, for example) and the main memory 16 without the intervention of the CPU 11. The PIC function serves to execute a predetermined program (interrupt handler) in response to an interrupt request (IRQ) from a peripheral device. The PIC function serves to generate a timer signal at a predetermined interval being programmable. The IDE interface function implements such interfaces as the connection of an IDE hard disk drive (HDD) 31 and the ATAPI (AT Attachment Packet Interface) connection of a CD-ROM drive 32. Instead of the CD-ROM drive 32, another type of IDE devices, such as a DVD (Digital Versatile Disc) drive may be connected. External storage devices such as the HDD 31, CD-ROM drive 32, etc. are housed, for example, in storage space called “media bay” or “device bay”, which is arranged inside the main body of the computer system 10.

The I/O bridge 21, which includes a USB port, is connected to a USB connector 30. In addition, an EEPROM 33 is connected to the I/O Bridge 21 via a SM bus. The EEPROM 33 is a nonvolatile and electrically rewritable memory for holding information, such as a password and a supervisor password each registered by a user and a product serial number.

The card bus controller 22 is a dedicated controller for connecting a bus signal of the PCI bus 20 directly to the interface connector (card bus) of a card bus slot 23. A PC card can be inserted to the card bus slot 23.

The audio subsystem 25, which is a chip (audio chip) for outputting sounds, generates sounds in a format of either FM sound source or PCM sound source. The FM sound source is a format which synthesizes sounds by combining a sine-wave signal with modulating signals called “modulator”. The PCM format generates sounds by converting the presence or absence, the level of sounds, etc. stored as digital data into waveform data.

A docking station interface 26 is a hardware used to connect a docking station (not shown) being a function extending device used in the case where the computer system 10 is a notebook personal computer.

An embedded controller 41, a flash ROM 44 and a Super I/O controller 45 are connected to the LPC bus 40, which is also used to connect peripheral devices operating with relatively low speed, such as a keyboard/mouse controller. The Super I/O controller 45 with an I/O port 46 connected thereto controls the driving of a FDD, the input/output of parallel data (PIO) via a parallel port and the input/output of serial data (SIO) via a serial port. A flash ROM 44 is a ROM capable of performing electrical data erasing or writing collectively or in blocks. The ROM 44 stores BIOS (Basic Input/Output system).

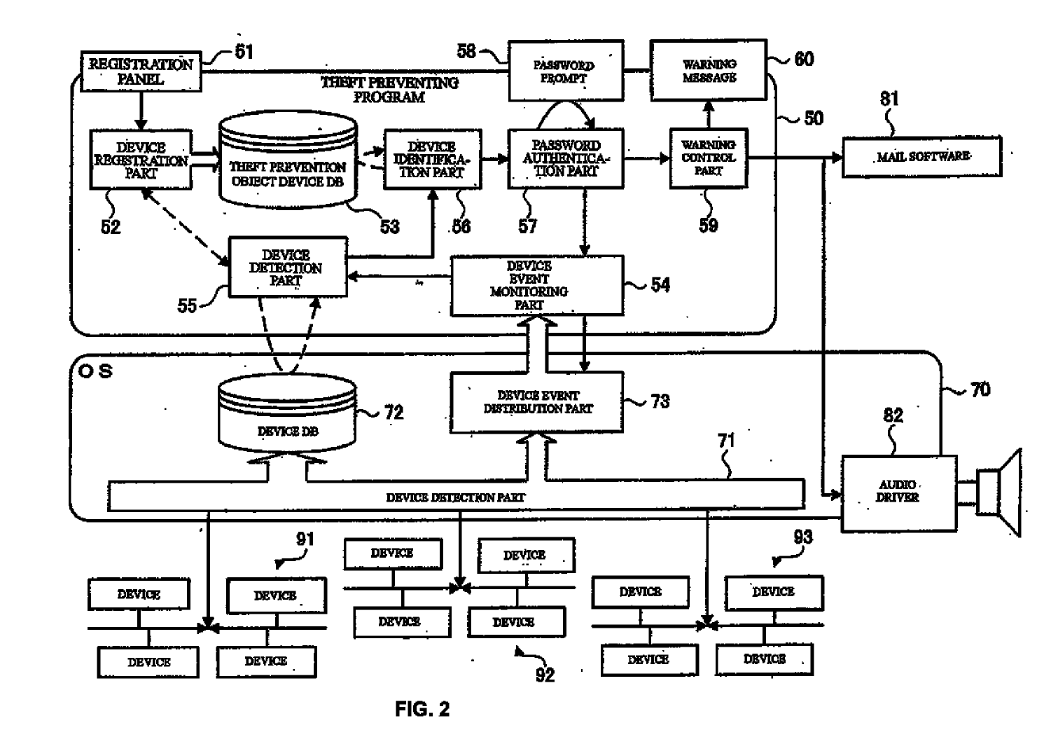

The functional configuration of the computer system 10 according to the embodiment will now be explained with reference to FIG. 2. One purpose of the invention is to prevent the removal of a removable device. Thus, taking for instance a theft being common as the purpose of removal, the invention will be explained below as a system for preventing a theft.

As shown in FIG. 2, in the computer system 10, a theft preventing application program 50 (referred to below as “theft preventing program”) and an operating system 70 (referred to below as “OS”) operate. Apart from the theft preventing program 50, mail software 81 being an application program for sending/receiving electronic mails operates. In addition, an audio driver 82 being software for controlling the audio output to the loudspeaker also operates. Groups of devices 91, 92, and 93 are also connected to the computer system 10.

In this configuration, when the CPU 11 of the computer system 10 reads the theft preventing program 50 into the main memory 16 for execution, the functions of a registration panel 51, a device registration part 52 (any part may be implemented as code and/or circuitry), a DB 53 for devices of theft prevention object (referred to below as “DB for devices of theft prevention object” or “theft prevention object device DB”), a device detection part 55, a device identification part 56, a device event monitoring part 54, a password authentication part 57, a password prompt 58, a warning control part 59 and a warning message 60 are implemented in the computer system 10.

The registration panel 51 is a user interface for inputting information to be registered in the DB 53 for devices of theft prevention object. The device registration part 52 serves to register the information being input via the registration panel 51 in the DB 53 for devices of theft prevention object. The device registration part 52 instructs the registration of information in the DB 53 for devices of theft prevention object, and therefore can also be perceived as a “registration instructing part”.

The DB 53 for devices of theft prevention object is a database for storing the information regarding devices specified by a user as theft prevention object. The specific storage contents of the DB 53 for devices of theft prevention object will be described later.

The device event monitoring part 54 serves to receive the notification of information regarding the change of device status from a device event distribution part 73 of the OS 70. The device detection part 55 serves to acquire from a device database (referred to below as “device DB”) 72 of the OS 70 detailed information regarding a device with respect to which the device event monitoring part 54 receives the notification. The device identification part 56 serves to determine whether or not the device regarding which the device detection part 55 acquires the detailed information is registered in the DB 53 for devices of theft prevention object, and therefore can also be perceived as a “determination part”.

The password authentication part 57 serves to perform password authentication with respect to a user attempting to remove a device. The password prompt 58 is a user interface being output onto the screen for password input.

The warning control part 59 serves to control issuing a warning. The warning message 60 indicates a message being output onto the screen by the warning control part 59. The warning control part 59 can also perform a warning by controlling mail software 81 and an audio driver 82; thus, these components relevant to warning can also be collectively called a “warning part”.

On the other hand, when the CPU 11 of the computer system 10 reads the OS 70 into the main memory 16 and executes, the functions of a device detection part 71, a device DB 72 and a device event distribution part 73 are implemented in the computer system 10.

The device detection part 71 serves to detect the change of status of each device connected to the computer system 10. The device DB 72 is a database for storing detailed information regarding all the devices connected to computer system 10. The device event distribution part 73 serves to inform the device event monitoring part 54 of the theft preventing program 50 about the change of device status detected by the device detection part 71.

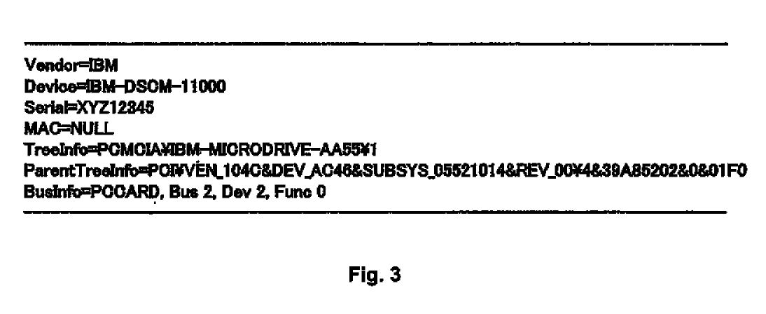

Specific storage contents of the DB 53 for devices of theft prevention object will now be explained with reference to FIG. 3. FIG. 3 shows exemplary information regarding a given device, which is stored in the DB 53 for devices of theft prevention object. Practically, sets of such information as many as devices are stored. In FIG. 3, only minimum information is shown for explanation. Practically, more detailed information is stored. In addition to the information shown in FIG. 3, a password (not shown) for each device, required when the device is removed is also stored.

The information stored in the DB 53 for devices of theft prevention object can be broadly divided into: (A) ID indicating the vendor of a device (referred to below as “vendor ID”); (B) ID indicating the kind of a device and the type of a product (referred to below as “product ID”); (C) numbers specific to individual device, such as serial number, MAC address of a LAN card, etc. (referred to below as “individual identification information”); and (D) Information indicating the connection destination of a device, such as slot number, port number, etc. (referred to below as “connection destination information”). Referring to the example shown in FIG. 3, (A) is indicated by a parameter following “Vendor=”; (B) is indicated by a parameter following “Device=” and a parameter following “TreeInfo=”; (C) is indicated by a parameter following “Serial=” and a parameter following “MAC=”; and (D) is indicated by a parameter following “TreeInfo=”, a parameter following “ParentTreeInfo=” and a parameter following “BusInfo=”.

In FIG. 3, all of (A) to (D) are stored as the device-related information. However, all of this information may not be stored to specify the device. For example, when the individual identification information can be acquired from all the devices, only the vendor ID, product ID and individual identification information are stored and the connection destination information may not be stored. On the other hand, when the individual identification information of a device can not be acquired, the individual identification information may not be stored and only the vendor ID, product ID and connection destination information are stored.

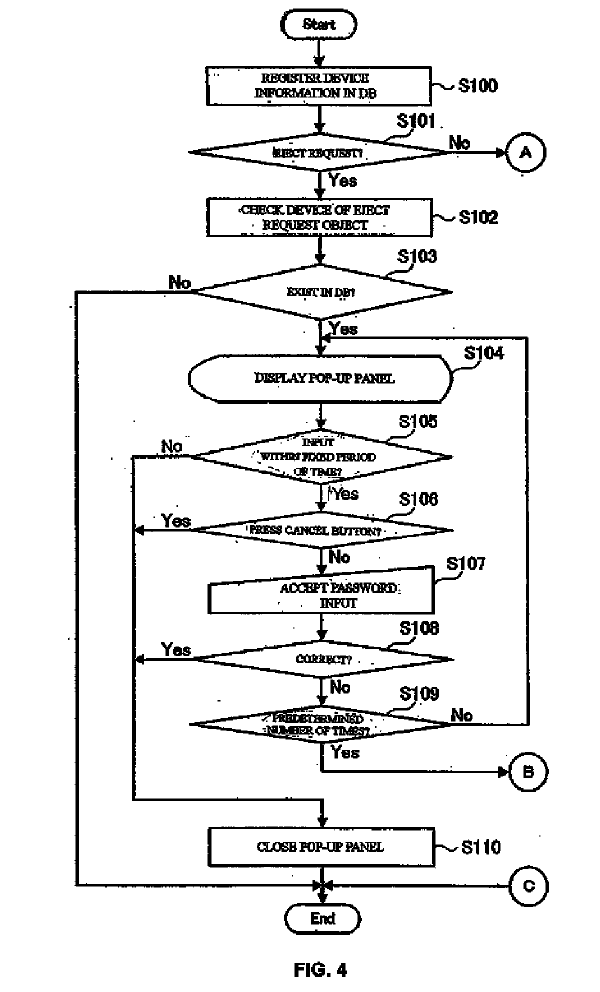

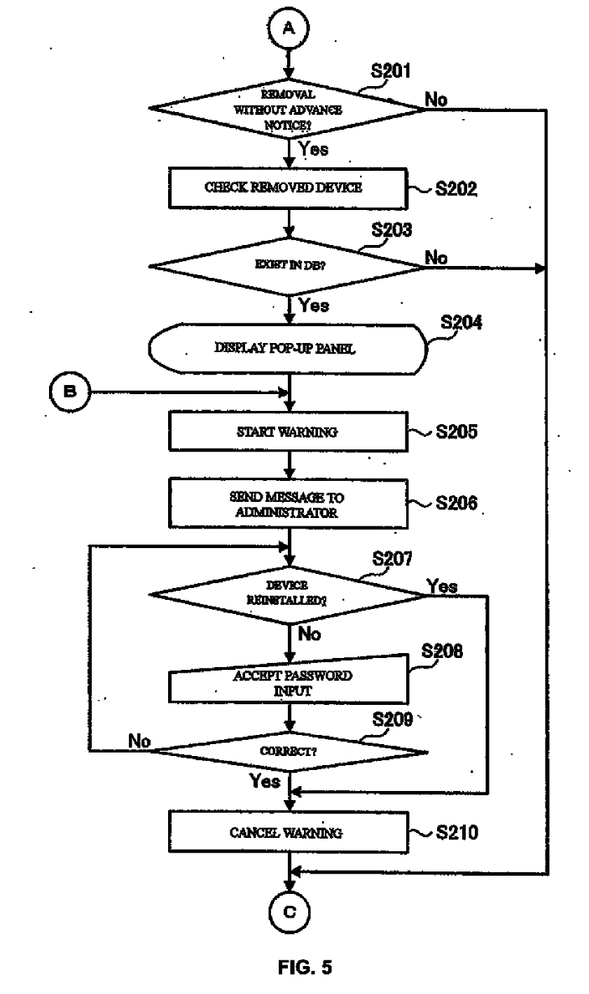

The operation of the computer system 10 according to the embodiment will now be explained below with reference to the FIGS. 4 and 5.

As shown in FIG. 4, according to the embodiment, firstly a device of theft prevention object is registered in the DB 53 for devices of theft prevention object (Step 100). Specifically, when a user specifies the information regarding the device to be protected and the password for the device by use of the registration panel 51, the device registration part 52 stores this information into the DB 53 for devices of theft prevention object. In this case, a device being inserted into the Device Bay and a device being connected to the PC card, USB port or PS/2 port can be registered. As shown in FIG. 3, the information regarding the device also includes the vendor ID, product ID, etc. of the device, the individual identification information such as the serial number, and the connection destination information.

After the registration of the information in the DB 53 for devices of theft prevention object, the computer system 10 executes Step 101 and subsequent processes (steps) shown in FIG. 4 or the processes shown in FIG. 5.

Firstly an operation, when Eject request is made on the screen, will be explained with reference to FIG. 4. The Eject request operation on the screen can be performed by use of the “Unplug or eject hardware” icon of a system tray in the case of Windows (registered trademark) of Microsoft Inc. of USA, and by use of EasyEject utility in the case of a ThinkPad (registered trademark) computer of IBM Inc. of USA.

When Eject request is made, the device event distribution part 73 informs the device event monitoring part 54 about the event.

In response to this, the device event monitoring part 54 determines whether Eject request has been made (Step 101). As a result, if Eject request has not been made, the flow proceeds to the process (step) shown in FIG. 5. On the other hand, if Eject request has been made, the device detection part 55 checks the target device for which Eject request has been made, through the device DB 72 (Step 102). Specifically, sent from the device event distribution part 73 to the device event monitoring part 54 is only the minimum information such that Eject request has been made for some device; therefore the device detection part 55 acquires detailed information such as “for which device connected to which port the Eject request has been made” and “what the serial number of the device is”.

The acquired detailed information is sent to the device identification part 56. The device identification part 56 determines whether the information regarding the device is registered in the DB 53 for devices of theft prevention object (Step 103). Specifically, it is determined whether a set of data, acquired by the device detection part 55, regarding the vendor ID, product ID and individual identification information is stored in the DB 53 for devices of theft prevention object. Alternatively, it may be determined whether a set of data, acquired by the device detection part 55, regarding the vendor ID, product ID and connection destination information is stored in the DB 53 for devices of theft prevention object. As a result, if it is not stored, the operation is finished. On the other hand, if it is stored, then the password authentication part 57 displays the password prompt 58 (pop-up panel) to request the input of a password (Step 104).

The password authentication part 57 determines whether the password input is made within a fixed period of time (one minute, for example) (Step 105). As a result, if a password is not input within a fixed period of time, the password prompt 58 (pop-up panel) is closed (Step 110). On the other hand, if some input operation is conducted within a fixed period of time, then it is determined whether the operation is a pressing of the cancel button (Step 106). As a result, if the cancel button is pressed, the password prompt 58 (pop-up panel) is closed (Step 110). On the other hand, if the cancel button is not pressed, the password input is accepted (Step 107).

After the password input is accepted, the password authentication part 57 determines whether the input password is correct (Step 108). Specifically, in the DB 53 for devices of theft prevention object, it is determined whether the password corresponds to the one associated with the target device for which Eject request has been made. As a result, if the password corresponds, the password prompt 58 (pop-up panel) is closed (Step 110). On the other hand, if the password does not correspond, then it is determined whether the number of incorrect password inputs reaches a predetermined number of times (three times, for example) (Step 109). As a result, if it does not reach, the flow returns to Step 104 to repeat the process. On the other hand, if it reaches, the flow proceeds to a warning generation process shown in FIG. 5 while displaying the password prompt 58 (pop-up panel). In this case, the password prompt 58 (pop-up panel) may be closed to cancel the Eject process without proceeding to the warning generation process.

Referring to FIG. 4, when the determination results in Steps 105 is “No”, 106 and 108 are “Yes”, the password authentication part 57 performs only the process of closing the password prompt 58 (pop-up panel). However, in practice, a process of sending the result of password authentication to the device event monitoring part 54 is also executed in addition to the above process. The device event monitoring part 54 performs a process corresponding to the result thus sent. The contents of the process vary between the two cases: (1) when the determination results in Steps 105 is “No” and 106 is “Yes” and (2) when the determination result in Step 108 is “Yes”. Specifically, when the determination results in Steps 105 is “No” and 106 is “Yes”, the device event monitoring part 54 sends back a reply of Eject request rejection to the device event distribution part 73. On the other hand, when the determination result in Step 108 is “Yes”, the device event monitoring part 54 sends back a reply of Eject request permission to the device event distribution part 73. The device event distribution part 73 performs a process in accordance with the response sent from the device event monitoring part 54.

A description will now be given below of the operation performed when a device is removed without making Eject request on the screen (the case of removal without advance notice).

When a device is removed in this way, the device event distribution part 73 informs the device event monitoring part 54 about the event.

In response to the above information, the device event monitoring part 54 determines whether this is a removal without advance notice (Step 201). As a result, if not so, the operation is finished. On the other hand, if so, the device detection part 55 checks the removed device through the device DB 72 (Step 202). Specifically, sent from the device event distribution part 73 to the device event monitoring part 54 is only the minimum information such that some device has been removed; therefore the device detection part 55 acquires detailed information such as “which device connected to which port has been removed” and “what the serial number of the device is.”

The detailed information thus acquired is sent to the device identification part 56. The device identification part 56 determines whether the information regarding the device is registered in the DB 53 for devices of theft prevention object (Step 203). Specifically, it is determined whether a set of data, acquired by the device detection part 55, regarding the vendor ID, product ID and individual identification information is stored in the DB 53 for devices of theft prevention object. Alternatively, it may be determined whether a set of data, acquired by the device detection part 55, regarding the vendor ID, product ID and connection destination information is stored in the DB 53 for devices of theft prevention object. As a result, if not stored, the operation is finished. On the other hand, if stored, then the password authentication part 57 displays the password prompt 58 (pop-up panel) to request the input of a password (Step 204).

In this case, the warning control part 59 also starts the generation of a warning (Step 205).

As this warning, the following methods are assumed, for example.

Firstly, the system volume is set to the maximum; a warning sound is output from the system loudspeaker. In this case, the system must be arranged so that the sound is forcibly output from the system loudspeaker even when a headphone is inserted into the headphone jack.

Secondly, the monitor-off function is turned off and a flashy warning message is displayed on the screen.

Thirdly, the warning control part 59 sends a warning message to the system administrator (Step 206).

This warning continues until the removed device is reconnected or reinstalled to the original place within a fixed period of time, or until the correct password is received. Firstly it is determined whether the removed device is reconnected (Step 207). Specifically, the device event monitoring part 54 detects the reconnection of the device; the device detection part 55 acquires the detailed information regarding the reconnected device; the device identification part 56 determines whether the information regarding the reconnected device is registered in the DB 53 for devices of theft prevention object. More specifically, it is determined whether a set of data, acquired by the device detection part 55, regarding the vendor ID, product ID and individual identification information is stored in the DB 53 for devices of theft prevention object. Alternatively, it may be determined whether a set of data, acquired by the device detection part 55, regarding the vendor ID, product ID and connection destination information is stored in the DB 53 for devices of theft prevention object. As a result, if the removed device is reconnected, the warning control part 59 cancels the warning (Step 210). On the other hand, if the removed device is not reconnected, then the password authentication part 57 accepts the password input (Step 208).

After the password input is accepted, the password authentication part 57 determines whether the input password is correct (Step 209). Specifically, in the DB 53 for devices of theft prevention object, it is determined whether the input password corresponds to the one associated with the removed device. As a result, if not so, the flow returns to Step 207 to repeat the process. On the other hand, if so, the warning control part 59 cancels the warning (Step 210).

The present embodiment is premised on such an assumption that the computer system 10 is at work or in operating state. Keeping the computer system 10 at work can also be implemented by an operational method such as “the computer system 10 is at work at all times during business hours of the store, etc. where it is installed, and is kept inside the store, etc. outside business hours.”

However, a novice user can erroneously or a malicious user can intentionally execute the shutdown, suspending, hibernation or log-off, etc. of the computer system 10. Thus, measures against these actions must also be taken. According to the embodiment, a password is set for executing the shutdown, suspending, hibernation or log-off, etc. of the computer system 10. When such an operation is executed, a pop-up panel is displayed to request the input of a password. If the correct password is input, the shutdown, suspending, hibernation or log-off, etc. of the computer system 10 is executed accordingly. If an incorrect password is input predetermined times (three times, for example) or if a password is not input within a fixed period of time (one minute, for example), then the pop-up panel is closed to cancel the shutdown, suspending, hibernation or log-off, etc. of the computer system 10.

Apart from the shutdown, suspending, hibernation or log-off, etc, the removal of the AC adaptor can cause the computer system 10 to enter the non-operating state. As a measure against the removal of the AC adaptor, an AC adaptor removal authentication tool may be provided. Before removing the AC adaptor, the tool is activated to input a password. If the correct password is input, nothing happens even when the AC adaptor is removed. However, if the AC adaptor is removed while the authentication process is not performed by the tool, then a pop-up panel is displayed on the screen to request the input of a password and at the same time a warning starts. The warning continues until the correct password is input or until the AC adaptor is re-inserted.

Accordingly, it is possible to keep the computer system placed in a public space at work at all times to permit many unspecified users to use it.

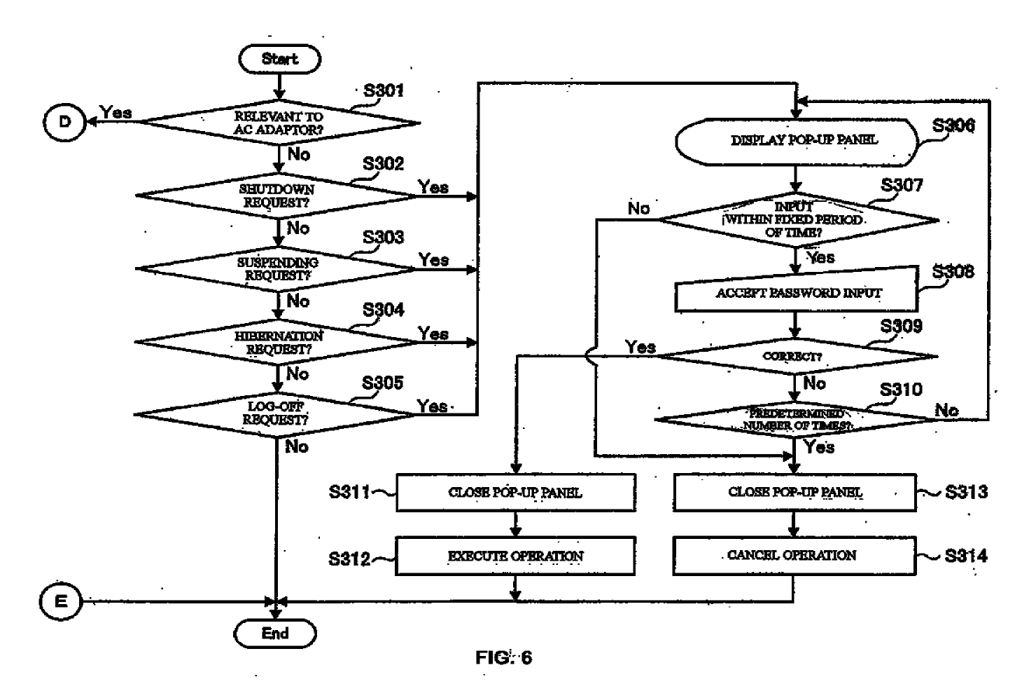

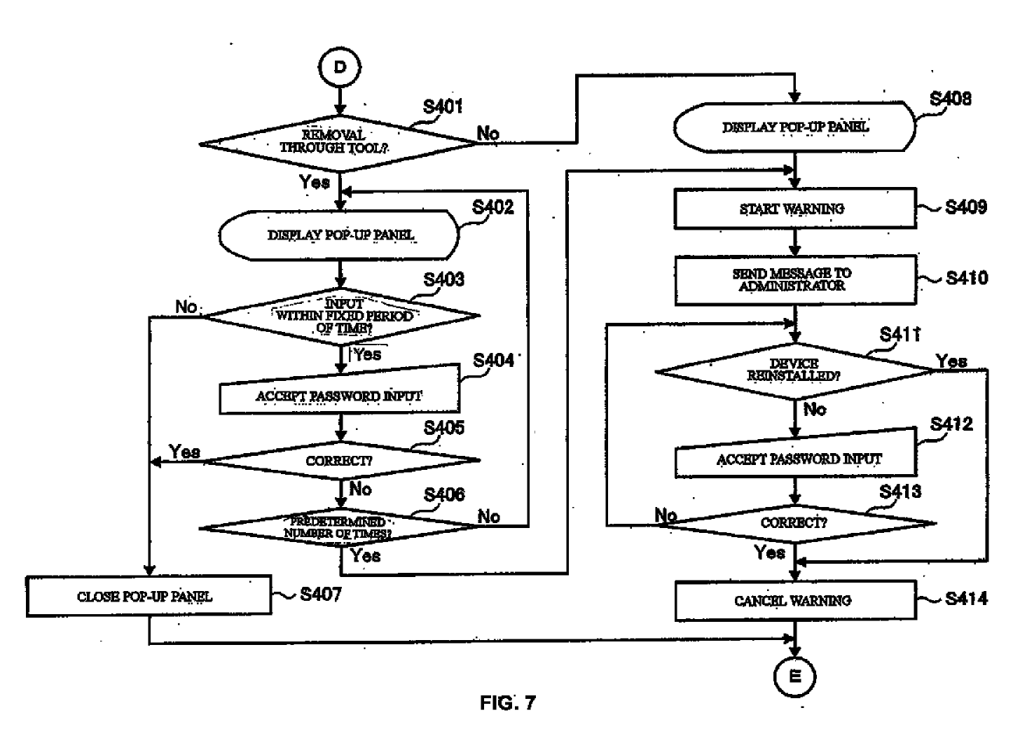

A description will now be given below of the operation of the computer system 10 in the above case with reference to FIGS. 6 and 7.

FIG. 6 is a flowchart showing the operation of the computer system 10 when a request for shutdown, suspending, hibernation or log-off, etc. is made.

Firstly the computer system 10 determines whether the operation is relevant to the AC adaptor (Step 301). As a result, if so, the flow proceeds to a process shown in FIG. 7. On the other hand, if not so, then it is determined whether the operation is of shutdown, suspending, hibernation or log-off, etc. Specifically, firstly it is determined whether the operation is a shutdown request (Step 302). If not so, then it is determined whether the operation is a suspending request (Step 303). If not so, it is determined whether the operation is a hibernation request (Step 304). If not so, it is determined whether the operation is a log-off request (Step 305). If not so, the operation is finished. On the other hand, if it is determined in Step 302 that the operation is a shutdown request, or if it is determined in Step 303 that the operation is a suspending request, or if it is determined in Step 304 that the operation is a hibernation request, or if it is determined in Step 305 that the operation is a log-off request, then a password prompt (pop-up panel) is displayed to request the input of a password (Step 306).

The computer system 10 determines whether the password input is made within a fixed period of time (one minute, for example) (Step 307). As a result, if not so, the password prompt (pop-up panel) is closed (Step 313) to cancel the requested operation (Step 314). On the other hand, if some input is performed within a fixed period of time, the password input is accepted (Step 308).

After the password input is accepted, the computer system 10 determines whether the input password is correct (Step 309). Specifically, it is determined whether the input password corresponds to the predetermined password. As a result, if so, the password prompt (pop-up panel) is closed (Step 311) to execute the requested operation (Step 312). On the other hand, if not so, it is determined whether the number of incorrect password inputs reaches a predetermined number of times (three times, for example) (Step 310). As a result, if not so, the flow returns to Step 306 to repeat the process. On the other hand, if so, the pop-up panel is closed (Step 313) to cancel the requested operation (Step 314).

FIG. 7 is a flowchart showing the operation of the computer system 10 when the AC adaptor is removed.

Firstly it is determined whether the removal request is made through the AC adaptor removal authentication tool (Step 401). As a result, if so, a password prompt (pop-up panel) is displayed to request the input of a password (Step 402).

The AC adaptor removal authentication tool determines whether the password input is made within a fixed period of time (one minute, for example) (Step 403). As a result, if not so, the password prompt (pop-up panel) is closed (Step 407) to cancel the removal request. On the other hand, if some input is made within a fixed period of time, the password input is accepted (Step 404).

After the password input is accepted, the AC adaptor removal authentication tool determines whether the input password is correct (Step 405). Specifically, it is determined whether the input password corresponds to the predetermined password. As a result, if so, the password prompt (pop-up panel) is closed (Step 407). The subsequent process in this case is different from when the determination in Step 403 is “No” and the pop-up panel is closed; a process is performed in accordance with the removal request. On the other hand, if the correspondence of the password is not obtained, it is determined whether the number of incorrect password inputs reaches a predetermined number of times (three times, for example) (Step 406). As a result, if not so, the flow returns to Step 402 to repeat the process. On the other hand, if so, the flow proceeds to a warning generation process starting from Step 409 while displaying the password prompt (pop-up panel).

If it is determined in Step 401 that the removal request is not made through the AC adaptor removal authentication tool, a password prompt (pop-up panel) is displayed to request the input of a password (Step 408) and the generation of a warning also starts (Step 409). In addition, a warning message is sent to the system administrator (Step 410).

The warning continues until the removed AC adaptor is reconnected within a fixed period of time, or until the correct password is input. Specifically, firstly it is determined whether the AC adaptor is reconnected (Step 411). As a result, if so, the warning is canceled (Step 414). On the other hand, if not so, the input of a password is accepted (Step 412).

After the password input is accepted, the computer system 10 determines whether the input password is correct (Step 413). Specifically, it is determined whether the input password corresponds to a predetermined password. As a result, if not so, the flow returns to Step 411 to repeat the process. On the other hand, if so, the warning is canceled (Step 414).

With the above, the operation according to the embodiment is finished.

According to the embodiment described above, a password for each device is registered in the DB 53 for devices of theft prevention object. Alternatively, in one embodiment, a common password for all devices may be registered. Instead of password authentication, biometric authentication by fingerprint, voiceprint, etc. or card authentication by ID card, etc. may be employed. Furthermore, apart from these authentication methods, the validity of removal of a removable device may be verified by another method. In this sense, the “password authentication part” can also be perceived as a “verification part for verifying the validity of a removal request or a removal action with respect to a removable device.”

According to the embodiment described above, the vendor ID and product ID are invariably stored in the database for devices of theft prevention object. However, if it is enough for a warning to be issued in response that a removal request or removal action is made for a removable device connected to the connection destination having the slot number, port number, etc. that are in advance registered in the database for devices of theft prevention object, then only the connection destination information may be stored without storing the vendor ID and product ID.

The method for preventing the removal of a removable device according to the embodiment can be deployed as a program for enabling a computer to implement the function of preventing the removal of a removable device. As a form of providing a computer with the above program, a notebook PC may be provided with the program installed therein, for example. Alternatively, there may be provided a program product having a computer-readable storage medium in which the program to be executed by a notebook PC, etc. is stored. Appropriate media as the above storage medium include DVD and CD-ROM, for example. In this case, the program is read out by a DVD reader, a CD-ROM reader or the like, and is stored in flash ROM, etc. for execution. Alternatively, the program may be provided via a network, for example, by a program transmission apparatus.

When the present invention is perceived as an invention of the above described storage medium, the invention may be described as follows: “a storage medium storing a program for implementing a function of determining whether the information regarding a removed removable device is registered in a database where the information regarding removable devices of removal prevention object is stored and a function of issuing a warning when it is determined that the information regarding the removed removable device is registered in the database.”

In this case, the information regarding removable devices of removal prevention object may be the information regarding the connection destination of a removable device; the above determination function may determine whether the information regarding the connection destination to which the removed removable device has been connected is registered in a database where the information regarding the connection destination of a removable device is stored.

Alternatively, in one embodiment, the information regarding removable devices of removal prevention object may be the identification information for uniquely identifying a removable device; the above determination function may determine whether the identification information regarding the removed removable device is stored in a database where the identification information for uniquely identifying a removable device is stored. In this case, the storage medium may store a program for further implementing a function such that if the identification information regarding the installed removable device is stored in the database, the warning halts.

Alternatively, in one embodiment, the information regarding removable devices of removal prevention object may be the information regarding the kind of a removable device and the information regarding the connection destination of the removable device; the above determination function may determine whether the information regarding the kind of the removed removable device and the information regarding the connection destination to which the removable device has been connected are registered in a database where the kind of a removable device and the information regarding the connection destination of the removable device are registered. In this case, the storage medium may store a program for further implementing a function such that if the information regarding the kind of the installed removable device and the information regarding the connection destination to which the removable device is connected are registered in the database, the warning halts.

As described above, according to the embodiment, the information regarding removable devices of removal prevention object is in advance registered in a database. Then, only if the information regarding a removable device for which a removal request or a removal action is made is registered in the database, the validity of the removal request or the removal action is verified. Accordingly, it is possible to prevent a device requiring removal prevention from being removed without impairing the operability in removing a device not requiring removal prevention.

As the information regarding removable devices of removal prevention object, the vendor ID, product ID and individual identification information are employed; if the above information regarding a removed removable device is registered in the database, a warning is issued; if the above information regarding an installed removable device is registered in the database, the warning halts. Accordingly, it is possible to unfailingly prevent a device requiring removal prevention from being removed and carried away without impairing the operability in removing a device not requiring removal prevention.

Alternatively, in one embodiment, as the information regarding removable devices of removal prevention object, the vendor ID, product ID and connection destination information are employed; if the above information regarding a removed removable device is registered in the database, a warning is issued; if the above information regarding an installed removable device is registered in the database, the warning halts. In this configuration, even when another individual device having the same vendor ID and product ID as the removed removable device is connected to the same connection destination, the warning halts. However, from a viewpoint of preventing resources attached to a computer system from being reduced by thefts, the above case is permissible because the same product is unfailingly connected to the predetermined connection destination (even if it is a different individual device). In other words, even when the information for identifying an individual device, such as the serial number, can not be acquired from a removable device, it is possible to unfailingly prevent a device requiring removal prevention from being removed and carried away.

Embodiments of the present invention include various functions, which have been described above. The functions may be performed by hardware circutry or may be embodied in machine-executable instructions as firmware or software, which may be used to cause a general-purpose or special-purpose processor circuitry programmed with the instructions to perform the functions. Alternatively, the functions may be performed by a combination of hardware, firmware and software.

In the drawings and specifications there has been set forth a preferred embodiment of the invention and, although specific terms are used, the description thus given uses terminology in a generic and descriptive sense only and not for purposes of limitation.

Additionally, terms used generically in the following claims are not limited to the specific embodiments disclosed. For clarity, and not for purposes of limitation, the table which follows provides at least one disclosure terminology example for each generic claim term.

| Non-limiting Disclosure Example | Generic Claim Term |
|---|---|
| registration instructing part | registration circuit |
| determination part | information circuit |
| verification part | validity circuit |
| warning part | warning circuit |

1. Apparatus comprising:
a registration circuit which instructs the registration of a first information regarding a removable device of removal prevention object;
a database which stores the first information of which registration is instructed by said registration circuit;
an information circuit which determines whether a second information regarding the removable device for which an occurrence of a removal operation is stored in said database, wherein the removal operation is an operation selected from the group consisting of a removal request and a removal action; and
a validity circuit which verifies the validity of the removal operation, if said information circuit determines that the second information is stored in said database.

2. Apparatus according to claim 1, wherein:
said database stores a password set for each of a plurality of removable devices of removal prevention object; and
said validity circuit verifies the validity of the removal operation through an authentication which uses the password set for each removable device for which the removal operation is made.

3. Apparatus according to claim 1, wherein said validity circuit verifies the validity of the removal operation through any of password authentication, biometric authentication, and card authentication.

4. The computer according to claim 1, further comprising a warning circuit which issues a warning in response to, as a result of the validity of authentication by said validity circuit, determining that the removal operation is invalid.

5. Apparatus according to claim 1, wherein:
said registration circuit instructs registration of information regarding a connection destination of the removable device of removal prevention object as the first information; and
said information circuit determines whether the information regarding the connection destination to which the removable device for which the occurrence of the removal operation is stored has been connected is stored in said database as the second information.

6. Apparatus according to claim 4, wherein:
said registration circuit instructs registration of an identification information for uniquely identifying the removable device of removal prevention object as the first information;
said information circuit determines whether the identification information of the removable device for which the occurrence of the removal operation is stored in said database as the second information; and
said warning circuit halts the warning in response to the identification information of the removable device for which an installing action is performed being stored in said database.

7. Apparatus according to claim 4, wherein:
said registration circuit instructs registration of an information regarding the kind and connection destination of the removable device of removal prevention object as the first information;
said information circuit determines whether the information regarding the kind of the removable device for which a removal action is performed and the information regarding the connection destination to which the removable device has been connected are stored in said database as the second information; and
said warning circuit halts the warning in response to the information regarding the kind of the removable device for which the installing action is performed and the information regarding the connection destination to which the removable device is connected being stored in said database.

8. Apparatus according to claim 4, wherein said warning circuit issues a warning through audio output, screen display, or message transmission to a predetermined destination.

9. A method comprising:
registering information regarding a removable device of removal prevention object in a database by means of a computer; and
issuing a warning in response to information regarding a removed removable device being registered in said database.

10. The method according to claim 9, wherein:
in said step of registering the information, information regarding a connection destination of a removable device is registered as the information regarding the removable device of removal prevention object; and
in said step of issuing the warning, the warning is issued in response to the information regarding the connection destination to which the removed removable device has been connected being registered in said database.

11. The method according to claim 9, further comprising:
a step of halting a warning in response to identification information of an installed removable device being registered in said database;
wherein:
in said step of registering the information, identification information for uniquely identifying a removable device is registered as the information regarding said removable device of removal prevention object; and
in said step of issuing the warning, the warning is issued in response to the identification information of the removed removable device being registered in said database.

12. The method according to claim 9, wherein:
in said step of registering the information, information regarding the kind and connection destination of a removable device is registered as the information regarding said removable device of removal prevention object; and
in said step of issuing the warning, the warning is issued in response to the information regarding the kind of the removed removable device and the information regarding the connection destination to which said removable device has been connected being stored in said database, and
halting the warning in response to the information regarding the kind of the installed removable device and the information regarding the connection destination to which said removable device is connected being stored in said database.

13. A product comprising:
a computer usable medium having computer readable program code stored therein, the computer readable program code in said product implements functions including:
a function of registering information regarding a removable device of removal prevention object in a predetermined database;
a function of determining whether information regarding a removed removable device is registered in said database; and
a function of issuing a warning in response to determining that the information regarding said removed removable device is registered in said database.

14. The product according to claim 13, wherein in said function of determining, it is determined whether information regarding the connection destination to which the removed removable device has been connected is registered in the database where the information regarding the connection destination of a removable device is registered as the information regarding said removable device of removal prevention object.

15. The product according to claim 13, said code further implements a function of halting a warning in response to identification information of an installed removable device being stored in the database, wherein in said function of determining, it is determined whether the identification information of said removed removable device is registered in the database where the identification information for uniquely identifying a removable device is registered as the information regarding said removable device of removal prevention object.

16. The product according to claim 13, wherein the code further implements
a function of halting a warning in response to an information regarding the kind of an installed removable device and the information regarding the connection destination to which the removable device is connected being stored in said database, wherein in said function of determining, it is determined whether the information regarding the kind of the removed removable device and the information regarding the connection destination to which said removable device has been connected are registered in the database where the information regarding the kind and connection destination of a removable device is registered as the information regarding said removable device of removal prevention object.
